(19) United States
(12) Patent Application Publication
(10) Pub. No.: US 2020/0076174 A1
(43) Pub. Date: Mar. 5, 2020

(54) CABLE COATING REMOVAL DEVICE

(71) Applicants: YAZAKI CORPORATION, Tokyo (JP); JAPAN CHAIN TERMINAL CO., LTD., Tendo-shi (JP)

(72) Inventors: Akiya NUMAZAWA, Tendo-shi (JP); Youichi Oyama, Tendo-shi (JP)

(73) Assignees: YAZAKI CORPORATION, Tokyo (JP); JAPAN CHAIN TERMINAL CO., LTD., Tendo-shi (JP)

(21) Appl. No.: 16/558,553

(22) Filed: Sep. 3, 2019

(30) Foreign Application Priority Data
Sep. 4, 2018 (JP) 2018-165419

(51) Int. Cl. H02G 1/12

(52) U.S. Cl. CPC H02G 1/1265; H02G 1/127; H02G 1/1268

(57) ABSTRACT

A cable coating removal device which is configured to remove a coating of a core wire in an end portion of a cable, the coating removal device includes: a hollow rotation shaft including, at a front end of the hollow rotation shaft, a rotary type stripping head which is configured to strip off the coating; a cable holding mechanism which is configured to hold and fix the end portion of the cable in front of the stripping head such that the end portion of the cable W is aligned with an axis of the rotation shaft; cutters which are provided on the stripping head and are displaceable in a radial direction of the rotation shaft to cut the coating of the cable; and a suction mechanism which is configured to remove stripping wastes of the coating generated by the cutters through a hollow portion of the rotation shaft.

### CROSS REFERENCE TO RELATED APPLICATIONS

This application is based on and claims priority from Japanese patent application No. 2018-165419 filed on Sep. 4, 2018, the entire contents of which are incorporated herein by reference.

### BACKGROUND OF THE INVENTION

### 1. Technical Field

The present invention relates to a cable coating removal device having a function of recovering stripping wastes of a coating.

### 2. Background Art

When a coating around a core wire at an end portion of a cable which is an electric wire or the like is removed, a coating removal device including a cutter which moves in a radial direction of the cable is used. The coating removal device cuts the coating in a vicinity of a tip end of the cable by, for example, a pair of cutters. In the cut state, the coating on a tip end side is stripped off from a cutting position by relatively retracting the cutters with respect to a coated electric wire.

In this type of coating removal device, when a large number of coating removal processes are continuously performed, stripping wastes are generated one after another. The stripping wastes are likely to adhere to the cutters due to static electricity or the like. Therefore, the stripping wastes are generally removed by suction. For example, It is known that a suction pipe for suction of the stripping wastes is disposed on back surfaces (also referred to as lateral sides) of the pair of cutters, and the stripping wastes are removed by suction together with air from a tip end opening of the suction pipe (see Patent Document JP-A-7-95710).

In this type of coating removal device, one including a rotary type stripping head is known (see Patent Document JP-A-2017-93283). The coating removal device is to cut the coating of the cable with a cutting edge of a cutter while rotating a stripping head including the cutter.

Removal of stripping wastes of a coating is required even in a coating removal device including a rotary type stripping head. However, a rotation shaft of the stripping head hinders installation of a suction pipe, so that a simple structure has not been developed.

### SUMMARY

The present invention has been made in view of the above circumstances, and an aspect of the present invention is to provide a cable coating removal device which can reliably remove stripping wastes of a coating by suction while having a simple structure in coating removal devices including a rotary type stripping head.

In order to achieve the above aspect, a cable coating removal device according to the present invention is characterized by the following (1) to (4).

(1) A cable coating removal device which is configured to remove a coating of a core wire in an end portion of a cable, the coating removal device comprising:

a hollow rotation shaft including, at a front end of the hollow rotation shaft, a rotary type stripping head which is configured to strip off the coating;

a cable holding mechanism which is configured to hold and fix the end portion of the cable in front of the stripping head such that the end portion of the cable is aligned with an axis of the rotation shaft;

cutters which are provided on the stripping head and are displaceable in a radial direction of the rotation shaft to cut the coating of the cable; and

a suction mechanism which is configured to remove stripping wastes of the coating generated by the cutters through a hollow portion of the rotation shaft.

(2) The cable coating removal device according to above configuration (1), further comprising:

an axial movement mechanism which has a function of moving the stripping head and the cable holding mechanism in an axial direction of the rotation shaft relatively and is configured to move the stripping head and the cable holding mechanism in directions away from each other such that cutting edges of the cutters have cut into the coating.

(3) The cable coating removal device according to above configuration (2), further comprising:

a stripping unit on which the rotation shaft is rotatably mounted,

wherein the stripping unit is mounted on a base member so as to be linearly movable along the axial direction of the rotation shaft, and the cable holding mechanism is fixed in front of the stripping unit, and

wherein the axial movement mechanism is configured to move the stripping unit linearly.

(4) The cable coating removal device according to above configuration (2),

wherein a suction pipe forming a suction passage of the suction mechanism is passed through the hollow portion of the rotation shaft, and

wherein a front end of the suction pipe communicates with a rear space of the cutters, and a rear end of the suction pipe is connectable to a suction source.

According to the cable coating removal device having the configuration (1), the cutting edges of the cutters are smoothly cut into the coating by displacing (closing the cutters) the cutters radially inward while rotating the stripping head in a vicinity of the end of the cable held and fixed by the cable holding mechanism, whereby the coating on the tip side with respect to the cutting position of the cutting edges can be stripped off. At this time, the stripped wastes of the coating can be suctioned from the front end to the rear end of the rotation shaft and removed to the outside through the hollow portion of the rotation shaft by operating the suction mechanism before the coating is completely stripped off. Accordingly, the stripping wastes is removed through the hollow portion of the rotation shaft by suction. Therefore, a suction path can be secured without being disturbed by the rotation shaft. Therefore, even in the coating removal device including the rotary type stripping head, it is possible to reliably remove the stripping wastes by suction while having a simple structure.

According to the cable coating removal device having the configuration (2), the cutting edges cut into the coating to a position where the core wire is not damaged by displacing (closing the cutters) the cutters radially inward while rotating the stripping head, and the cutters are kept at that position or displaced (the cutters are opened) radially outward to a position on an inner peripheral side of an outer diameter of the coating to be stripped off as necessary. In this state, the stripping head is relatively retracted relative to the cable. Therefore, the coating on the tip side with respect to the cutting position of the cutting edges can be stripped off while removal of the stripping wastes can be performed by suction.

According to the cable coating removal device having the configuration (3), the stripping head can be moved relative to the cable with a cable position being fixed. Therefore, the cable can be easily handled, and removal of the stripping wastes can be reliably performed by suction without causing any unexpected damage to the cable.

According to the cable coating removal device having the configuration (4), the stripping wastes can be removed by suction using the suction pipe which is passed through the hollow portion of the rotation shaft.

According to the present invention, the stripping wastes is removed through the hollow portion of the rotation shaft by suction. Therefore, the suction path can be secured without being disturbed by the rotation shaft. Therefore, even in the coating removal device including the rotary type stripping head, it is possible to reliably remove the stripping wastes by suction while having a simple structure.

The present invention has been briefly described as above. Details of the present invention will be further clarified by reading a mode (hereinafter, referred to as “embodiment”) for carrying out the present invention described below with reference to the accompanying drawings.

### BRIEF DESCRIPTION OF THE DRAWINGS

FIG. 1 is an external perspective view of a cable coating removal device according to an embodiment of the present invention.

FIG. 2 is a longitudinal cross-sectional view of the coating removal device.

FIG. 3 is an enlarged view of a main part in FIG. 2.

FIG. 4 is a side view illustrating a configuration of a cutter opening and closing mechanism in the coating removal device, which illustrates a state when cutters are in an open position.

FIG. 5 is a side view illustrating the configuration of the cutter opening and closing mechanism in the coating removal device, which illustrates a state when the cutters are in a closed position.

FIG. 6 is a front view illustrating a configuration of an attachment portion of the cutters in the coating removal device.

FIG. 7 is a side view of an operation process by the coating removal device, which illustrates a state when a stripping unit is to be advanced in an arrow A direction such that a cable is held by a cable holding mechanism and the cutters are in the open position.

FIG. 8 is a side view of a process next to the operation process in FIG. 7, which illustrates a state when the stripping unit is stopped at a cutting position and the cutters are operated to the closed position to cut the coating of the cable with cutting edges of the rotating cutters.

FIG. 9 is an illustrative view of a process next to the process in FIG. 8, which illustrates a state when the stripping unit is retracted from the cutting position in a arrow B direction to strip off the coating to expose a core wire of the cable.

### DETAILED DESCRIPTION OF EMBODIMENTS

A specific embodiment according to the present invention will be described with reference to drawings.

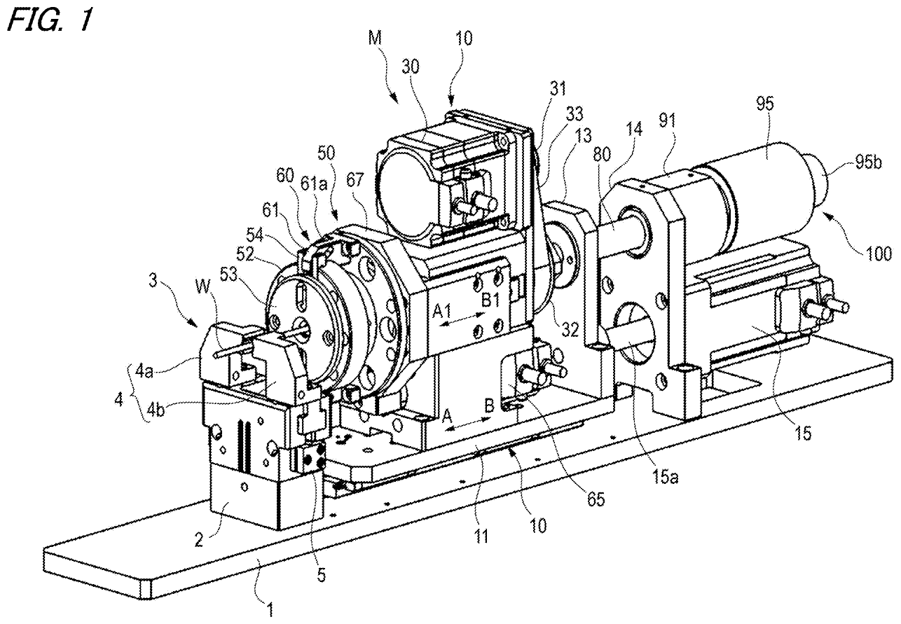

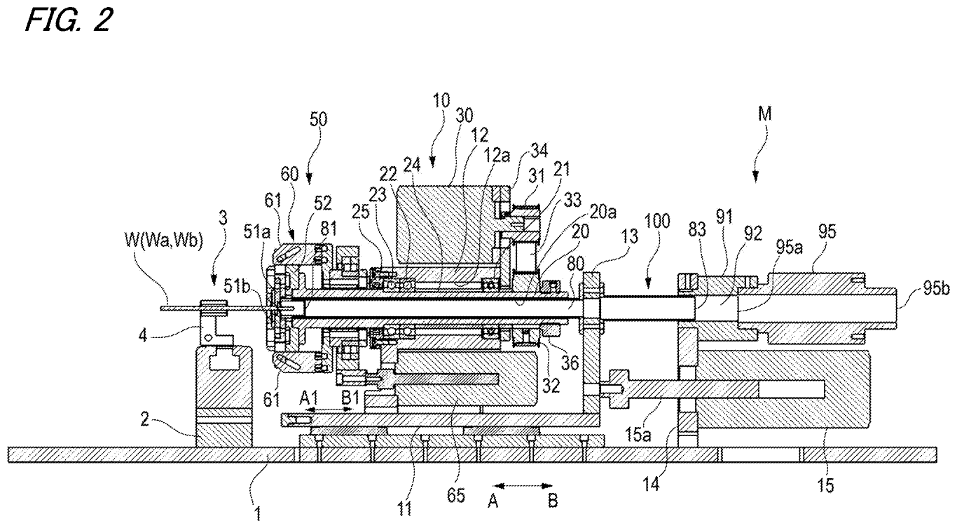

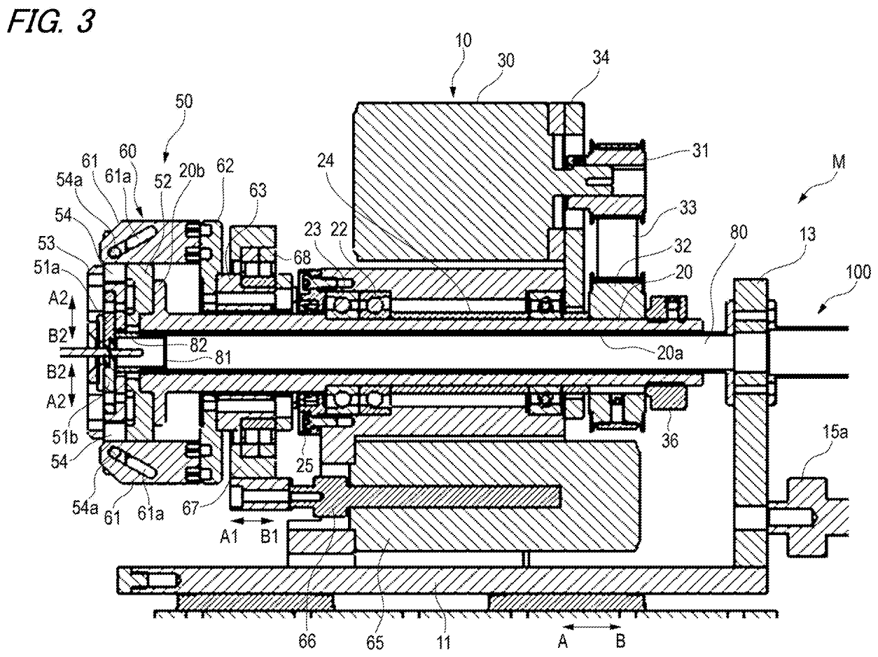

FIG. 1 is an external perspective view of a cable coating removal device according to an embodiment. FIG. 2 is a longitudinal cross-sectional view. FIG. 3 is an enlarged view of a main part in FIG. 2.

A coating removal device M according to the embodiment illustrated in FIGS. 1 to 3 is configured to remove a coating Wb of an end portion of a cable W which is a coated electric wire to expose a core wire Wa.

As illustrated in FIGS. 1 to 3, the coating removal device M includes a stripping unit 10 which is linearly movable in an arrow A direction and an arrow B direction diametrically opposite to each other in a horizontal direction on a base plate (base member) 1. Here, the arrow A direction is referred to as a forward direction, and the arrow B direction is referred to as a rearward direction.

The stripping unit 10 includes a unit base 11 which is linearly slidable in the arrow A direction and the arrow B direction on the base plate 1. The unit base 11 is guided in a movement direction by a rail or the like. A block-shaped unit body 12 is fixed on the unit base 11. At a rear end of the unit base 11, a vertical wall 13 is provided at an interval on a rear side of the unit body 12. Accordingly, the unit base 11, the unit body 12, and the vertical wall 13 move integrally.

A fixed wall 14 fixed on the base plate 1 is provided on a rear side of the stripping unit 10. A forward and rearward movement actuator 15, which is configured to advance and retract the stripping unit 10 in the arrow A direction and the arrow B direction, is attached to the fixed wall 14. The forward and rearward movement actuator 15 is a linear actuator which linearly moves an actuating rod 15a. A tip end of the actuating rod 15a is connected to the vertical wall 13 of the stripping unit 10. Accordingly, the stripping unit 10 is advanced in the arrow A direction by extending the actuating rod 15a of the forward and rearward movement actuator 15. Further, the stripping unit 10 is retracted in the arrow B direction by retracting the actuating rod 15a.

The block-shaped unit body 12 of the stripping unit 10 is formed with a through hole 12a having a circular cross section penetrating in the arrow A direction and the arrow B direction. A rotation shaft 20 is passed through the through hole 12a. The rotation shaft 20 is supported at a rear end side by a bearing 21 and supported at a front end side by bearings 22, 23 in two stages, so as to penetrate an inside of the through hole 12a rotatably. Thus, an axis of the rotation shaft 20 is set to be parallel to the arrow A direction and the arrow B direction, which are linear sliding directions of the stripping unit 10.

A bracket plate 34 is connected to a rear end of the unit body 12. The bracket plate 34 closes a rear end opening of the through hole 12a of the unit body 12, and positions the bearing 21 fitted to an inner periphery of the through hole 12a in an axial direction. A drive motor 30, which is configured to drive the rotation shaft 20 rotationally, is attached to an upper portion of the bracket plate 34. The drive motor 30 is a stepping motor. A drive pulley 31 is attached to an output shaft of the drive motor 30. A rear end of the rotation shaft 20 protrudes rearward from the rear end of the unit body 12. A driven pulley 32 is attached to the rear end of the rotation shaft 20. A timing belt 33 is wound around the drive pulley 31 and the driven pulley 32. The rotation shaft 20 is rotated by rotation of the drive motor 30. The driven pulley 32 is positioned in the axial direction by a fixing ring 36 attached to the rear end of the rotation shaft 20.

A cylindrical spacer 24, which defines an axial interval between the bearings 21, 22, is provided on an outer periphery of the rotation shaft 20 between the bearing 22 that rotatably supports a front end side of the rotation shaft 20 and the bearing 21 that rotatably supports a rear end side of the rotation shaft 20. The bearing 23, which rotatably supports the front end side of the rotation shaft 20, is axially positioned by a fixing ring member 25.

A front end of the rotation shaft 20 protrudes largely from the unit body 12 of the stripping unit 10. At the front end of the rotation shaft 20, a rotary type stripping head 50, which is configured to strip off a coating of the cable (coated electric wire) W, is attached so as to rotate integrally with the rotation shaft 20.

A flange portion 20b is integrally formed at the front end of the rotation shaft 20. A disk-shaped cutter mounting plate 52 is connected to a front side of the flange portion 20b. A pair of cutter holders 54 are attached to the cutter mounting plate 52 so as to be slidable in the radial direction and to face each other by 180° in a circumferential direction. Cutters 51a, 51b are attached to each of the cutter holders 54 with a V-shaped cutting edge being directed to a rotation center (an extension line of the axis of the rotation shaft 20) of the cutter mounting plate 52. The cutters 51a, 51b are displaced radially inward and radially outward together with the cutter holders 54, so that the cutting edges can cut into the cable W when the cutters 51a, 51b are displaced inward. A cover 53 is attached to a front side of each of the cutter holders 54.

A slide disk 62 is provided on the outer periphery of the rotation shaft 20 on a rear side of the flange portion 20b so as to be slidable in the axial direction along the outer periphery of the rotation shaft 20 and to rotate integrally with the rotation shaft 20. A slide boss 63 is connected to an inner peripheral side of the slide disk 62 so as to move integrally with the slide disk 62. An outer periphery of the slide boss 63 is rotatably fitted to a slider 67 via a bearing 68. The slider 67 is a non-rotating member which is slidably supported with respect to the unit body 12 in the arrow A direction and the arrow B direction. The slider 67 is connected to a tip end of a rod 66 of a cylinder 65 which is a driving source of a cutter opening and closing mechanism 60. The cylinder 65 is fixed to the unit body 12 of the stripping unit 10. When the cylinder 65 is operated, the slide boss 63 and the slide disk 62 are moved forward and rearward in a arrow A1 direction and a arrow B1 direction while being allowed to rotate integrally with the rotation shaft 20 via the slider 67.

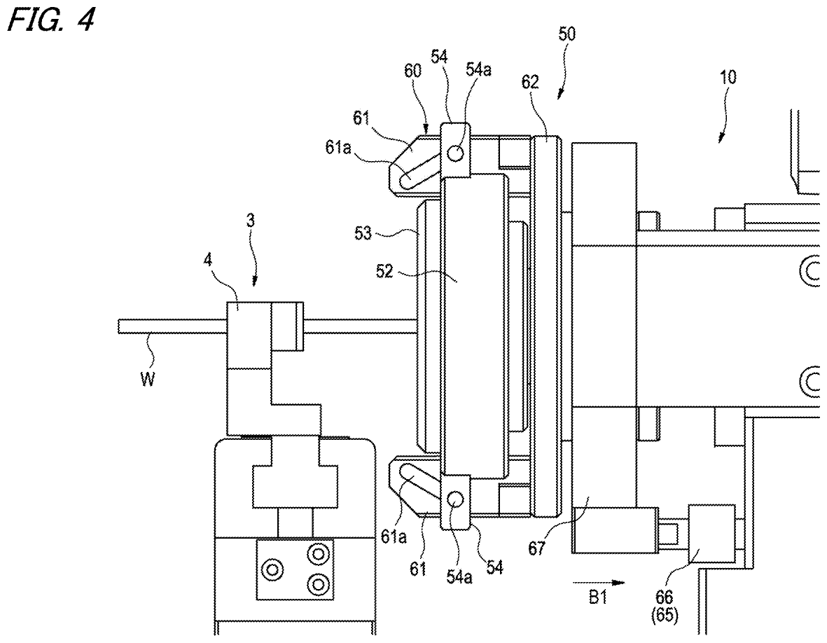

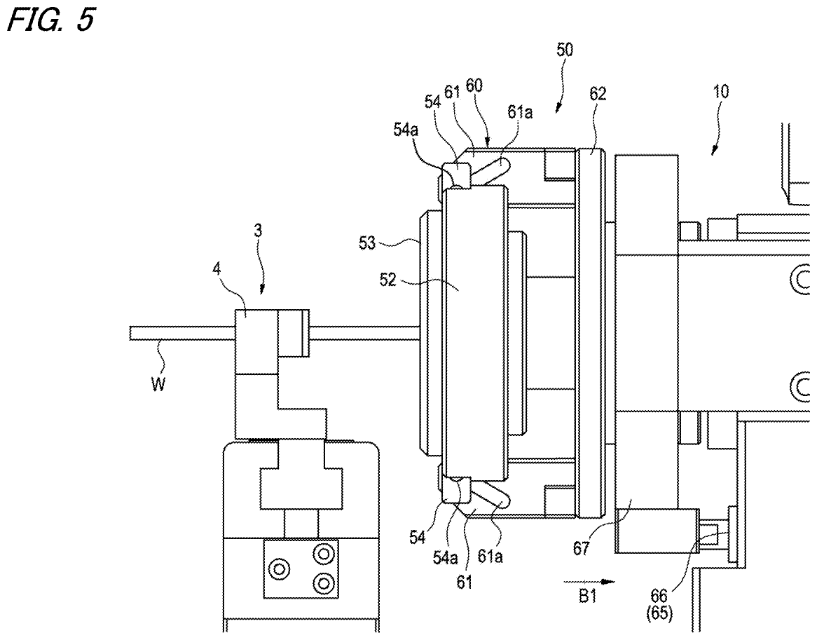

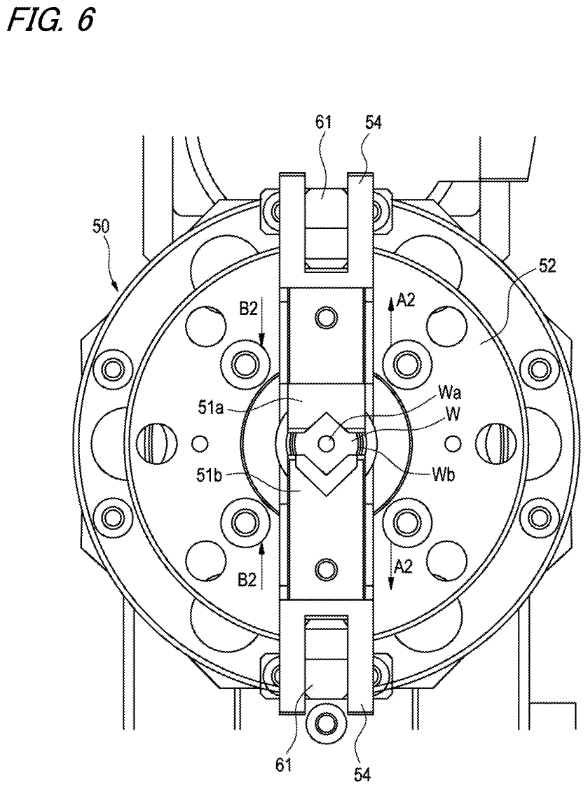

FIGS. 4 and 5 are diagrams illustrating a configuration of the cutter opening and closing mechanism 60. FIG. 4 is a side view illustrating a state when cutters are in an open position. FIG. 5 is a side view illustrating a state when the cutters are in a closed position. Further, FIG. 6 is a front view illustrating a configuration of an attachment portion of the cutters.

As illustrated in FIG. 3 and FIGS. 4 to 6, base ends of a pair of cam plates 61 are connected to an outer peripheral portion of the slide disk 62 to face each other by 180° in the circumferential direction. The pair of cam plates 61 are provided at positions corresponding to the cutter holders 54 attached to the cutter mounting plate 52 so as to be slidable in the radial direction. Cam grooves 61a are formed in the cam plates 61 protruding forward from the slide disk 62. The cutter holders 54 are provided with cam pins 54a. The cam pins 54a of the cutter holders 54 are slidably engaged with the cam grooves 61a of the cam plates 61, respectively.

The cutter holder 54 is displaced as follows by cam action of the cam groove 61a of the cam plate 61 and the cam pin 54a of the cutter holder 54. That is, as illustrated in FIG. 4, the cutter holder 54 is displaced outward in the radial direction as indicated by an arrow A2 in FIG. 6 by advancing the cam plate 61 with respect to the cutter holder 54 in an arrow A1 direction. As illustrated in FIG. 5, the cutter holder 54 is displaced inward in the radial direction as indicated by an arrow B2 in FIG. 6 by retracting the cam plate 61 with respect to the cutter holder 54 in an arrow B1 direction.

Here, when the cutter holder 54 is displaced inward in the radial direction, the pair of cutters 51a, 51b are set to be closed. When the cutter holder 54 is displaced outward in the radial direction, the pair of cutters 51a, 51b are set to be opened. As illustrated in FIG. 6, cutting edges of the cutters 51a, 51b can cut into the coating Wb of the cable W by closing the pair of cutters 51a, 51b. Finally, the cutting edges can be intersected to cut the core wire Wa by closing the pair of cutters 51a, 51b completely.

The cutter opening and closing mechanism 60 includes the cutter holder 54, the cam plate 61, the slide disk 62, the slide boss 63, the slider 67, the bearing 68, the cylinder 65, and the like. The stripping head 50 includes the flange portion 20b of the rotation shaft 20, the cutter mounting plate 52, the cutter holder 54, the cutters 51a, 51b, the cover 53, and a part of the cutter opening and closing mechanism 60.

A cable holding mechanism 3, which is configured to hold and fix the terminal portion of the cable W in front of the stripping head 50 such that the end portion of the cable W is aligned with the axis of the rotation shaft 20, is provided in front of the stripping unit 10. The cable holding mechanism 3 includes a clamp base 2 which is fixed on the base plate 1, a pair of left and right grip members 4 (4a, 4b) which can be opened and closed in a left-right direction on the clamp base 2, and an opening and closing actuator 5 which is configured to drive the grip members 4 (4a, 4b) to open and close. The opening and closing actuator 5 is operated to close the pair of grip members 4a, 4b, so that the end portion of the cable W can be held and fixed such that the terminal portion of the cable W is aligned with the axis of the rotation shaft 20 of the stripping unit 10.

In the present embodiment, the cable holding mechanism 3 is fixed and the stripping unit 10 (the stripping head 50) is moved forward and backward (toward and away) from the cable holding mechanism 3. Therefore, a mechanism (mainly the forward and rearward movement actuator 15), which is configured to advance and retract the stripping unit 10, corresponds to an axial movement mechanism. The forward and rearward movement actuator 15 is configured to simply move and position the stripping unit 10 in a front-rear direction (the arrow A direction and the arrow B direction). However, The forward and rearward movement actuator 15 can also perform a function of stripping the coating Wb when the stripping unit 10 is retracted. That is, the stripping head 50 is retracted in a direction away from the cable W such that the cutting edges of the cutters 51a, 51b have cut into the coating Wb of the cable W, so that the coating on the tip end side is stripped off from a position where the cutting edge cuts.

The cutter mounting plate 52 of the stripping head 50 is connected to the front end of the rotation shaft 20. The rotation shaft 20 is formed as a hollow shaft including a hollow portion 20a penetrating from a rear end of the rotation shaft 20 to a front end of the rotation shaft 20. A suction pipe 80 forming a suction passage of a suction mechanism 100 for suction of the stripping wastes of the coating Wb is passed through the hollow portion 20a of the rotation shaft 20 so as to rotate integrally with the rotation shaft 20.

The suction mechanism 100 removes the stripping wastes of the coating Wb generated by the cutters 51a, 51b through the hollow portion 20a of the rotation shaft 20, and is configured as a main component of the suction pipe 80. Therefore, a front end 81 of the suction pipe 80 communicates with a rear space of the cutters 51a, 51b via a front end pipe 82. A rear end 83 of the suction pipe 80 can be connected to a suction source (not illustrated) via a joint member (joint portion) 91 and a joint pipe 95 which allow the axial linear movement and rotation of the suction pipe 80. That is, the rear end 83 of the suction pipe 80 is fitted in a communication hole 92 of the joint member 91 so as to be rotatable and axially movable. A front end 95a of the joint pipe 95 is fitted to a rear end of the communication hole 92 of the joint member 91, so that the suctioned stripping wastes are discharged toward the suction source from a rear end 95b of the joint pipe 95.

Next, an operation will be described.

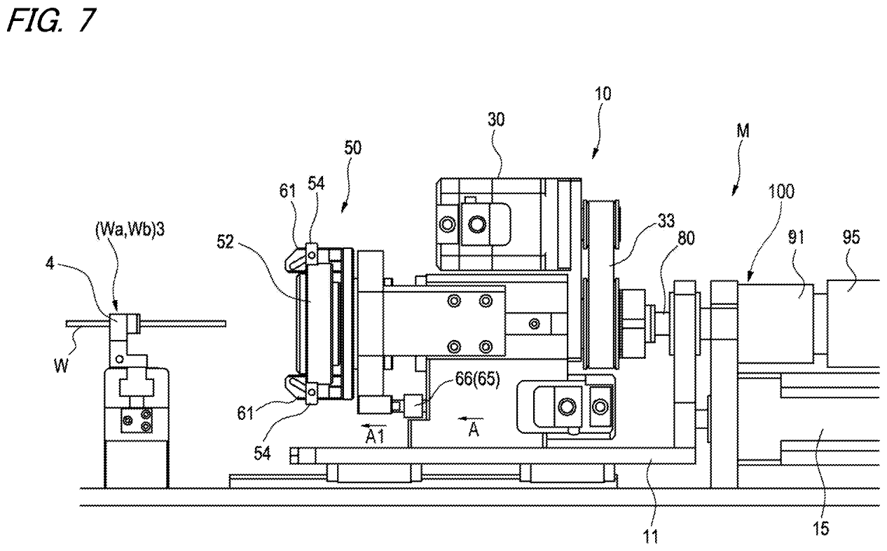

FIGS. 7 to 9 are illustrative views of an operation process performed by the coating removal device M.

When the coating Wb of the end portion of the cable W is stripped off to expose the core wire Wa, the process proceeds in a following order.

FIG. 7 is a side view illustrating a state when the stripping unit 10 is to be advanced in the arrow A direction such that the cable W is held by the cable holding mechanism 3 and the cutters 51a, 51b (see FIG. 6) are in the open position.

As illustrated in FIG. 7, first, the end portion of the cable W is held and fixed by closing the grip members 4 (4a, 4b) of the cable holding mechanism 3. As a result, the end portion of the cable W is maintained in alignment with the axis of the rotation shaft 20 of the stripping unit 10.

Next, the drive motor 30 is driven to rotate the rotation shaft 20 via a timing belt 33. At this stage, the cylinder 65 of the cutter opening and closing mechanism 60 holds the rod 66 at an extended position in the arrow A1 direction. Accordingly, the cam plate 61 is maintained at a forward position with respect to the cutter holder 54. That is, as illustrated in FIG. 4, the cam plate 61 is in the forward position, so that the cutters 51a, 51b are displaced in an arrow A2 direction in FIG. 6, and the cutters 51a, 51b are maintained in the open position. In this state, the forward and backward movement actuator 15 is actuated to advance the stripping unit 10 in the arrow A direction and to receive the cable W inside the stripping head 50.

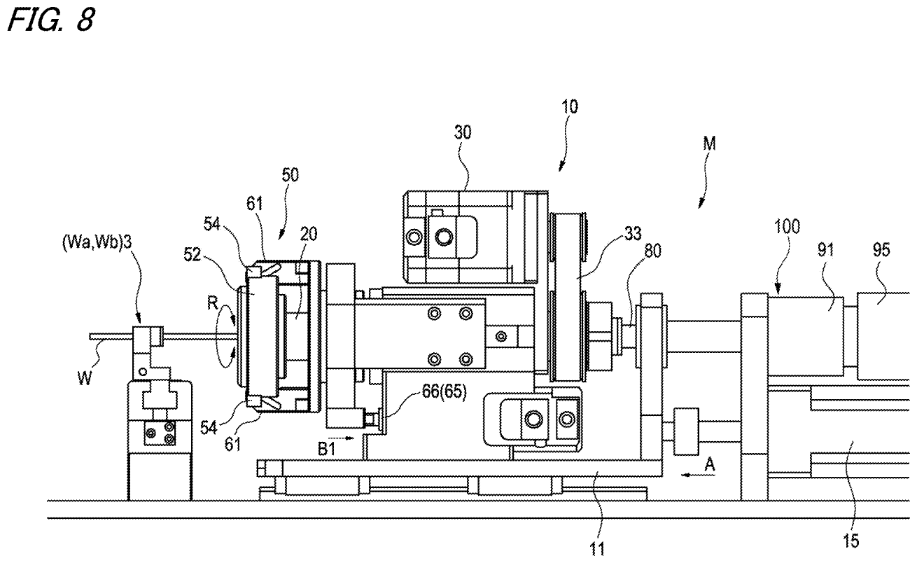

FIG. 8 is a side view of a process next to the operation process in FIG. 7, which illustrates a state when the stripping unit 10 is stopped at a cutting position and the cutters 51a, 51b are operated to the closed position to cut the coating Wb of the cable W with the cutting edges of the rotating cutters 51a, 51b.

As illustrated in FIG. 8, the stripping unit 10 advanced in the arrow A direction by the forward and backward movement actuator 15 is stopped at a predetermined position, that is, at a coating cutting position. Then, at the stopped position, the rod 66 of the cylinder 65 of the cutter opening and closing mechanism 60 is retracted in the arrow B1 direction. As a result, the cam plate 61 is retracted relative to the cutter holder 54. Accordingly, the cutters 51a, 51b are displaced in the arrow B2 direction (radially inward) in FIG. 6 to close the cutters 51a, 51b. As illustrated in FIG. 6, the cutting edges of the cutters 51a, 51b smoothly bite into the coating Wb by radial inward displacement (closing operation) of the cutters 51a, 51b and the rotation (rotation as indicated by an arrow R) of the cutters 51a, 51b. Immediately before the cutting edges of the cutters 51a, 51b reach the core wire Wa, operation of the cylinder 65 is stopped, and a radially inward movement of the cutters 51a, 51b is stopped.

Next, at that position, the cutters 51a, 51b are slightly opened as operation of step back. However, the cutting edges are stopped at a position on an inner peripheral side of an outer diameter of the coating Wb, and the cutting edges of the cutters 51a, 51b are kept at that position.

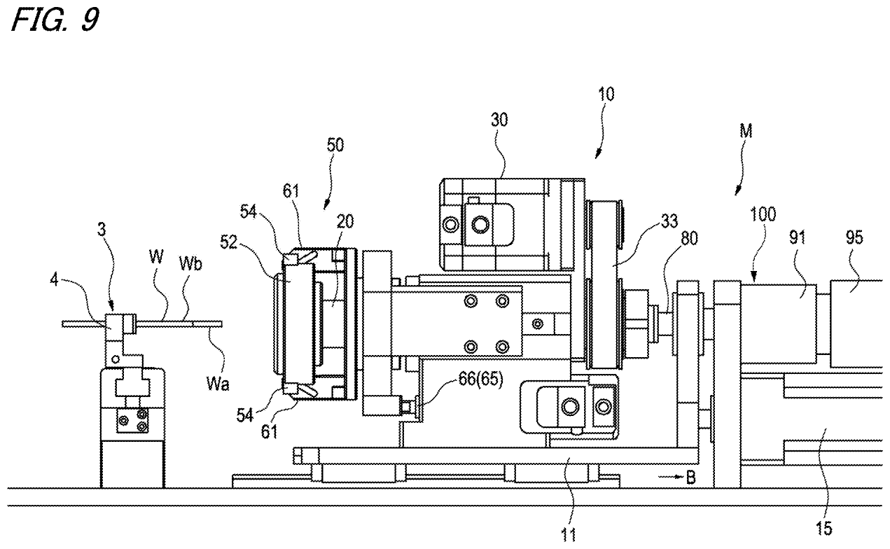

FIG. 9 is an illustrative view of a process next to the process in FIG. 8, which illustrates a state when the stripping unit 10 is retracted from the cutting position in the arrow B direction to strip off the coating to expose the core wire Wa of the cable W.

Next, as illustrated in FIG. 9, the stripping unit 10 is retracted in the arrow B direction such that the cutting edges of the cutters 51a, 51b have cut into the coating Wb of the cable W. As a result, the cutters 51a, 51b are retracted relative to the cable W as the stripping unit 10 is retracted, so that the coating Wb on the tip side with respect to the cutting position of the cutting edges is stripped off from the core wire Wa.

Before this stage, the suction operation performed by the suction mechanism 100 is started. In this step, when the coating Wb is completely stripped off, the stripping wastes are transferred by suction together with surrounding air in the suction pipe 80, and are discharged to an outside from the rear end 83 of the suction pipe 80.

As illustrated in FIG. 9, the following step may be inserted before the stripping unit 10 is completely retracted from the cable W.

That is, when the stripping unit 10 is retracted to the cutting position of the core wire Wa, the retraction is temporarily stopped. Then, the core wire Wa is cut by completely closing the cutters 51a, 51b at this position. Accordingly, a dimension (that is, an exit dimension of the core wire Wa) from the cutting position of the cutters 51a, 51b for the coating Wb to the tip end of the core wire Wa can be kept constant. Cutting wastes are transferred by suction together with the surrounding air in the suction pipe 80, and are discharged to the outside from the rear end 83 of the suction pipe 80. In this case, the stripping wastes of the coating Wb may be stuck together with the cutting wastes of the core wire Wa and discharged.

In any case, when the stripping of the coating Wb is completed, the stripping unit 10 is retracted to a standby position to prepare for a next cycle.

As described above, according to the coating removal device M of the embodiment, the stripped wastes of the coating Wb and the cutting wastes of the core wire Wa can be suctioned from the front end 81 of the rotation shaft 20 toward the rear end 83 and removed to the outside through the hollow portion 20a of the rotation shaft 20. Therefore, the suction path can be secured without being disturbed by the rotation shaft 20, and even in the coating removal device M including the rotary type stripping head 50, it is possible to reliably remove the stripping wastes or the like by suction while having a simple structure.

According to the coating removal device M in the embodiment, the rear end 83 of the suction pipe 80 is connected to the suction source via the joint member 91 which allows the axial linear movement and rotation of the suction pipe 80. Therefore, the joint member 91 to the suction source may be connected by a fixed pipe or a fixed hose. That is, the suction pipe 80 can be fixedly attached to the rotation shaft 20 without interfering the axial movement and rotation of the suction pipe 80 by providing the joint member 91.

The above embodiment has been described mainly with the case of removing a coating (insulating sheath) around a core wire of a single core coated electric wire. However, a concept of a coating to be removed includes, in addition to the insulation sheath of the single core coated electric wire in a related art, a dielectric around an inner conductor (central conductor) corresponding to the core wire in a case of a coaxial cable. Alternatively, the concept of the coating to be removed includes an outer conductor (braided wire or aluminum foil) surrounding the dielectric and an insulation coating on an outside of the dielectric along with the dielectric. That is, which range is referred to as a core wire and which range is referred to as a coating is determined by an operation case.

The above embodiment has assumed and describes that the cable is an electric wire. However, an operation object also includes an optical cable or the like other than the electric wire.

The suction pipe 80 rotates integrally with the rotation shaft 20 in the above embodiment. However, the suction pipe 80 may be configured not to rotate. In this case, for example, a flange is attached to the rear end 83 of the suction pipe 80, and the flange is fixed to the vertical wall 13 using a fastening member which is a bolt or the like. Then, the front end 81 side of the suction pipe 80 is inserted into the rotation shaft 20 to communicate with the rear space of the cutters 51a, 51b. At this time, the suction pipe 80 is cantilevered. A gap is formed between the outer peripheral surface of the suction pipe 80 and the inner peripheral surface of the rotation shaft 20. However, the rotation shaft 20 may slide relative to the suction pipe 80. A pipe separate from the suction pipe 80 is provided between the vertical wall 13 and the fixed wall 14. One end of this separate pipe is fastened to the vertical wall 13 using a flange or the like similarly to the rear end 83 of the suction pipe 80, and another end is fitted to the joint portion 91 as in the above embodiment. When the separate pipe is flexible, relative displacement of the stripping unit 10 and the suction source in the front-rear direction can be absorbed. Therefore, the other end of the separate pipe may be connected to the suction source not via the joint portion 91.

The cable holding mechanism 3 is fixedly provided and the stripping unit 10 is advanced and retracted relative to the cable holding mechanism 3 in the above embodiment. However, the cable holding mechanism 3 may be moved. That is, It is sufficient that the cable holding mechanism 3 and the stripping unit 10 move relative to each other in an approaching direction and an separating direction.

Here, features of the cable coating removal device according to the embodiment of the present invention described above will be briefly summarized in following [1] to [4].

[1] A cable coating removal device which is configured to remove a coating (Wb) of a core wire (Wa) in an end portion of a cable (W), the coating removal device including:

a hollow rotation shaft (20) including, at a front end of the hollow rotation shaft (20), a rotary type stripping head (50) which is configured to strip off the coating (Wb);

a cable holding mechanism (3) which is configured to hold and fix the end portion of the cable (W) in front of the stripping head (50) such that the end portion of the cable W is aligned with an axis of the rotation shaft (20);

cutters (51a, 51b) which are provided on the stripping head (50) and are displaceable in a radial direction of the rotation shaft (20) to cut the coating (Wb) of the cable (W); and

a suction mechanism (100) which is configured to remove stripping wastes of the coating (Wb) generated by the cutters (51a, 51b) through a hollow portion (20a) of the rotation shaft (20).

[2] The cable coating removal device according to [1], further including:

an axial movement mechanism (15) which has a function of moving the stripping head (50) and the cable holding mechanism (3) in an axial direction of the rotation shaft (20) relatively and is configured to move the stripping head (50) and the cable holding mechanism (3) in directions away from each other such that cutting edges of the cutters (51a, 51b) have cut into the coating (Wb).

[3] The cable coating removal device according to [2], further including:

a stripping unit (10) on which the rotation shaft (20) is rotatably mounted,

in which the stripping unit (10) is mounted on a base member (1) so as to be linearly movable along the axial direction of the rotation shaft (20), and the cable holding mechanism (3) is fixed in front of the stripping unit (10), and

in which the axial movement mechanism (15) is configured to move the stripping unit (10) linearly.

[4] The cable coating removal device according to [2] or [3],

in which a suction pipe (80) forming a suction passage of the suction mechanism (100) is passed through the hollow portion (20a) of the rotation shaft (20), and

in which a front end (81) of the suction pipe (80) communicates with a rear space of the cutters (51a, 51b), and a rear end (83) of the suction pipe (80) is connectable to a suction source.

What is claimed is:

1. A cable coating removal device which is configured to remove a coating of a core wire in an end portion of a cable, the coating removal device comprising:
a hollow rotation shaft including, at a front end of the hollow rotation shaft, a rotary type stripping head which is configured to strip off the coating;
a cable holding mechanism which is configured to hold and fix the end portion of the cable in front of the stripping head such that the end portion of the cable is aligned with an axis of the rotation shaft;
cutters which are provided on the stripping head and are displaceable in a radial direction of the rotation shaft to cut the coating of the cable; and
a suction mechanism which is configured to remove stripping wastes of the coating generated by the cutters through a hollow portion of the rotation shaft.

2. The cable coating removal device according to claim 1, further comprising:
an axial movement mechanism which has a function of moving the stripping head and the cable holding mechanism in an axial direction of the rotation shaft relatively and is configured to move the stripping head and the cable holding mechanism in directions away from each other such that cutting edges of the cutters have cut into the coating.

3. The cable coating removal device according to claim 2, further comprising:
a stripping unit on which the rotation shaft is rotatably mounted,
wherein the stripping unit is mounted on a base member so as to be linearly movable along the axial direction of the rotation shaft, and the cable holding mechanism is fixed in front of the stripping unit, and
wherein the axial movement mechanism is configured to move the stripping unit linearly.

4. The cable coating removal device according to claim 2,
wherein a suction pipe forming a suction passage of the suction mechanism is passed through the hollow portion of the rotation shaft, and
wherein a front end of the suction pipe communicates with a rear space of the cutters, and a rear end of the suction pipe is connectable to a suction source.
